(19) United States
(12) Patent Application Publication
(10) Pub. No.: US 2016/0297356 A1
(43) Pub. Date: Oct. 13, 2016

(54) PRINTED LED WARNING INDICATOR SIGNAL

(71) Applicant: FORD GLOBAL TECHNOLOGIES, LLC, Dearborn, MI (US)

(72) Inventors: Paul Kenneth Dellock, Northville, MI (US); Stuart C. Salter, White Lake, MI (US); Keith A. Hoelscher, Northville, MI (US); Michael A. Musleh, Canton, MI (US); Mary Beth Angotti, Canton, MI (US)

(21) Appl. No.: 14/684,496

(22) Filed: Apr. 13, 2015

(51) Int. Cl. B60Q 1/34; B60R 1/12; B60Q 1/26

(52) U.S. Cl. CPC B60Q 1/346; B60Q 1/2696; B60Q 1/2665; B60R 1/1207; B60R 2001/1223

(57) ABSTRACT

A warning indicator system for a vehicle includes an indicator for providing visible signals within a reflective surface of a rear-vision mirror. The indicator is operatively connected to a proximity sensor system and to a turn signal control system of the vehicle. The indicator provides a first visible signal when the turn signal control system is activated and provides a second visible signal when the turn signal control system and the proximity sensor system are activated. The first visible signal may be a first color and the second visible signal may be a second color that is different from the first color. The indicator may be defined by a first printed LED symbol for providing the first visible signal and a second printed LED symbol for providing the second visible signal. Rear-vision mirror assemblies including the described warning indicator system are provided.

### TECHNICAL FIELD

This disclosure relates generally to warning signals for motor vehicles. More particularly, the disclosure relates to an improved turn signal/blind spot indicator for a vehicle rear-vision mirror.

### BACKGROUND

It is known to provide mirror-mounted turn signal indicators in vehicles. When mounted in, e.g., a motor vehicle side mirror, turn signal indicators provide a visible warning of an impending turn or lane change to other vehicles, as a supplement to the main turn signal lights typically mounted at least at each of the four corners of the vehicle and associated respectively with the brake light and/or headlight arrays of the vehicle.

As is also known, conventional rear-vision mirror arrangements for a vehicle typically create a “blind spot” of varying size, i.e. an area to the side of and behind the vehicle which a driver cannot see by way of rear and/or side view mirrors without significant body movements (turning the head and/or torso, etc.). For this reason, modern motor vehicles are also often equipped with blind spot monitoring systems, typically provided as visual indicators operatively connected to proximity sensor systems. When a vehicle in an adjoining lane is within a driver's blind spot, i.e. is positioned near the driver's vehicle such that the driver may not see the adjoining vehicle in either of the rear or side view mirrors, the adjoining vehicle will still be detected by the proximity sensors, and a visible warning such as a fixed or flashing light is displayed. Viewing the visible warning, the driver is alerted that another vehicle is in an adjoining lane and near her car, and therefore that she should not attempt to change lanes or turn into the path of the adjoining vehicle. Such monitoring systems are also often associated with the vehicle side mirrors for convenient use by a vehicle driver.

Mirror-mounted blind spot indicators and turn signals are typically provided as separate elements (see FIGS. 1A and 1B), most often as separate indicators created by positioning one or more light sources such as light emitting diodes (LEDs) to emit a light of a desired color and pattern through the glass of the mirrored surface. Particularly in smaller side mirrors, this can occupy a significant portion of the mirrored surface, and indeed when activated has potential to contribute to the size of the vehicle's blind spot by reducing the amount of mirror surface usable by the driver. Also, the electronics associated with conventional LED-based turn signals and blind spot indicators, while relatively simple, occupy significant space and often require a sizable mirror housing to accommodate them. Such electronics also increase the cost and complexity of the vehicle manufacturing process, the cost of the vehicle to the consumer, and repair costs in the event mirror replacement/repair is required. In turn, conventional indicators such as blind spot indicators may be difficult to see, particularly for drivers with mirror visual impairments.

To solve this and other problems, the present disclosure relates to a combined turn signal/blind spot indicator for installation in a vehicle side mirror. Advantageously, the turn signal/blind spot indicator provides a turn signal indicator including a single visible light display which actuates differently depending on whether an adjacent vehicle is positioned in a driver's blind spot.

### SUMMARY

In accordance with the purposes and benefits described herein, in one aspect a warning indicator system is described providing a combined turn signal/blind spot warning indicator. Printed LED technology is used to provide a warning indicator that is cost-effective and provides a significantly larger warning indicator than a conventional blind spot warning light. In embodiments, printed LED technology is used to provide adjacent or overlapping printed LED decals defining the warning indicator, which is controlled by a processor operatively linked to the vehicle turn signal control system and the vehicle proximity sensor system. The warning indicator emits a first visible signal through the rear-vision mirror surface when the turn signal control system is activated, and emits a second visible signal through the rear-vision mirror surface when both the turn signal control system and proximity sensor system are activated.

In another aspect, a rear-vision mirror assembly is described incorporating the above-described warning indicator system.

In the following description, there are shown and described embodiments of the disclosed warning indicator system providing a combined turn signal/blind spot indicator. As it should be realized, the device is capable of other, different embodiments and its several details are capable of modification in various, obvious aspects all without departing from the devices and methods as set forth and described in the following claims. Accordingly, the drawings and descriptions should be regarded as illustrative in nature and not as restrictive.

### BRIEF DESCRIPTION OF THE DRAWINGS

The accompanying drawing figures incorporated herein and forming a part of the specification, illustrate several aspects of the disclosed warning indicator, and together with the description serve to explain certain principles thereof. In the drawing:

FIG. 1A depicts a conventional rear-vision mirror including a blind spot indicator signal;

FIG. 1B depicts a conventional rear-vision mirror including a turn signal indicator;

FIG. 2 depicts a printed LED indicator according to the present disclosure;

FIG. 3A depicts a basic circuit for a printed LED warning indicator according to the present disclosure;

FIG. 3B depicts the circuit of FIG. 3A including a layer of phosphor dye;

FIG. 4A shows a warning indicator disposed within a rear-vision mirror according to the present disclosure, operating in turn signal mode;

FIG. 4B shows the warning indicator of FIG. 4A, operating in turn signal/blind spot indicator mode;

FIG. 5A shows an alternative embodiment of the warning indicator of FIG. 4A;
and

FIG. 5B shows the warning indicator of FIG. 5A, operating in turn signal/blind spot indicator mode.

Reference will now be made in detail to embodiments of the disclosed warning indicator, examples of which are illustrated in the accompanying drawing figures.

### DETAILED DESCRIPTION

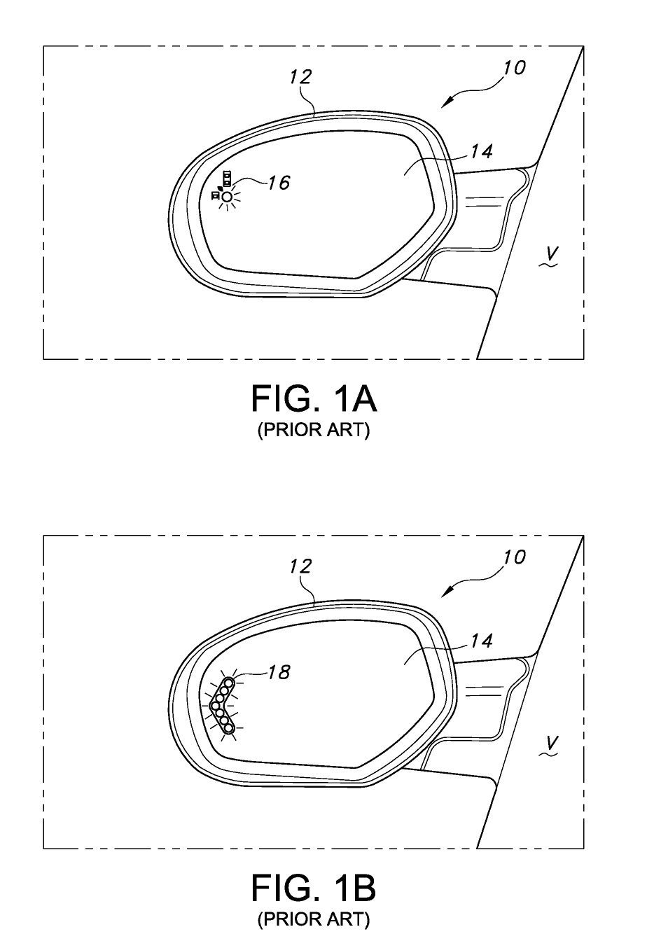

With reference to FIGS. 1A and 1B, vehicles may include rear-vision mirrors 10 having a housing 12 and a reflective surface 14, further including separate blind spot monitoring system indicators 16 and turn signal indicators 18 that are disposed to emit a visible signal through the reflective surface 14. Conventionally, blind spot monitoring system indicators 16 and turn signal indicators 18 (often provided by arranging multiple light emitting diodes (LEDs) in a desired shape such as a chevron, see FIG. 1B) are provided in specific colors known to catch the attention of drivers, adjacent motorists, etc. (typically red and/or yellow, which are colors generally associated with “warning” and “danger,” respectively). As noted above, conventional blind spot indicators such as those shown in FIGS. 1A and 1B may be difficult to see, and the electronics associated with conventional rear-vision mounted blind spot indicators and turn signal indicators add bulk and cost to the mirror assembly.

To address these issues, the present disclosure describes a combined turn signal/blind spot warning indicator provided by means of printed LED technology disposed within a reflective surface of a rear-vision mirror. At a high level, the described warning indicator is configured to emit a first warning signal through the rear-vision mirror reflective surface when activated by a vehicle turn signal control system and a second warning signal through the rear-vision mirror reflective surface when the vehicle turn signal control system is activated and a vehicle proximity sensor system detects the presence of an adjacent vehicle. The present disclosure and drawings describe such a warning indicator provided in vehicle driver's side view mirror. However, the skilled artisan will readily recognize that the technology is adaptable to passenger's side mirrors, rear view mirrors, etc. It will be appreciated that the described warning indicator may be provided as a supplement to a conventional blind spot indicator. Thus, the driver is alerted to the presence of an adjacent vehicle in her blind spot even when the vehicle turn signal control system is not activated.

Preliminarily, vehicle turn signal control systems and proximity sensor systems are well-known in the art, and do not require extensive discussion herein. However, as is known such turn signal control systems are typically activated by the vehicle driver, for example using controls mounted to a steering wheel column, to indicate to other motorists that a turn or lane change is imminent. As is also known, proximity sensor systems providing a blind spot warning to a driver may include camera-based proximity sensor systems, laser-based proximity sensor systems, sonar-based proximity sensor systems, infrared-based proximity sensor systems, ultrasonic wave-based proximity sensor systems, lidar-based proximity sensor systems, radar-based proximity sensor systems, and others.

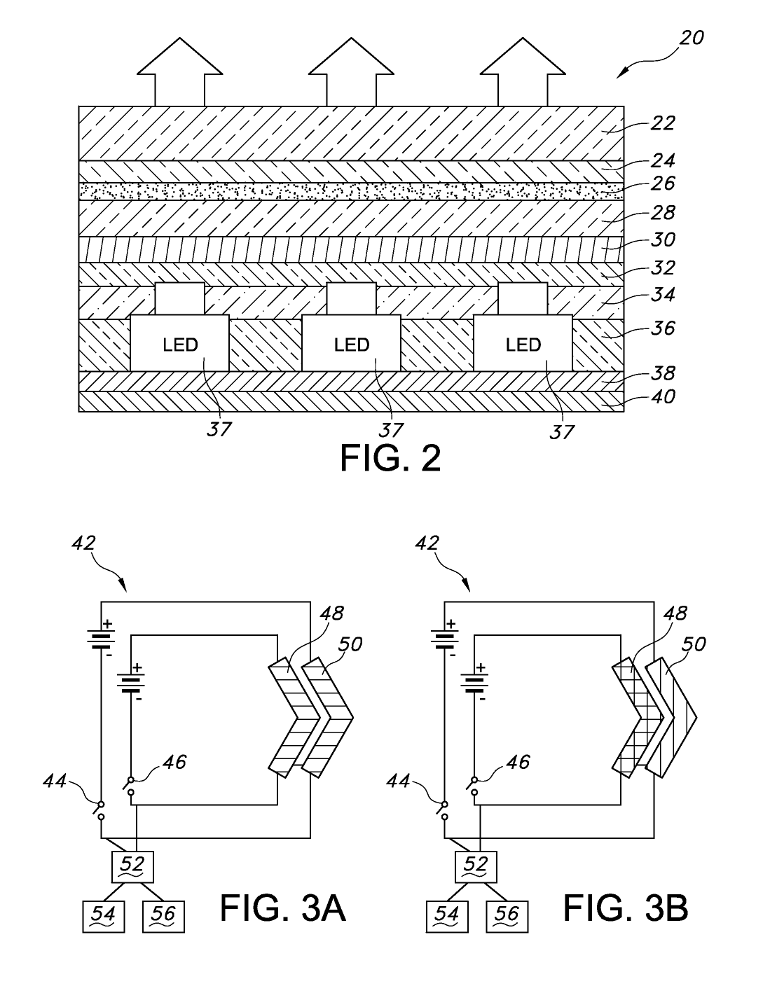

With reference to FIG. 2, in one embodiment a rear-vision mirror assembly 20 is provided. The assembly 20 includes a glass or polymer outer layer 22, and an at least partially reflective coating 24 in combination providing a reflective mirror surface. A portion of the reflective coating 24 may be masked or etched out to allow light from the warning indicator to be visible through the outer layer 22. In alternative embodiments, the reflective coating 24 may be semi-transparent or partially reflective (similar to a two-way mirror) to hide the warning indicator when not activated.

An adhesive layer 26 may be included to adhere the warning indicator to a rear side of the reflective coating 24. This may be a coating of a suitable adhesive, two-sided adhesive tape, etc. A clear substrate layer 28 is interposed between the adhesive layer 26 and a printed LED design (see description below). This may be an optically clear plastic film, an optically clear adhesive, etc., providing a surface that can be printed on.

For the printed LED design which forms the warning indicator of the present disclosure, it will be appreciated that multiple colors of LED could be used to create desired designs as the technology advances. However, for reasons of cost effectiveness it is known to use printed LEDs emitting a blue color, overlaid with a suitable phosphor or other dye to alter the color of the light emitted by the printed LEDs. In one embodiment, rylene phosphor and/or YAG phosphor dyes are used to change the color emitted by portions of the printed LEDs. As is known in the art, rylene and other phosphor dyes can be applied to shift the blue light emitted by LEDs to other desired color wavelengths, such as red and yellow.

Referring back to FIG. 2, one or more layers 30 of a phosphor dye are included providing, in combination with the light emitted by blue printed LEDs, a desired color. The phosphor dye layers 30 are deposited on a transparent conductive layer 32, which is turn adjacent to one or more transparent dielectric layers 34. A random diode ink (RDI) layer or layers 36 containing a plurality of LEDs 37 suspended in the ink is printed on the conductive layer 32, to provide a desired pattern such as a chevron or other suitable shape. A conductive ink layer or layers 38 carries an electrical charge to the LEDs 37 included in the RDI layer 36. Finally, an insulating plastic film base 40 is provided to serve as a base substrate for the printed LED, protecting and sealing the assembly from water, chemicals, dirt, etc. This may be fabricated of any suitable material such as MYLAR, polyester, or any suitable plastic or polymer film to which the conductive ink layer 38 can adhere. In combination, these layers provide a vertically connected diode array that is randomly spaced, and define a shape which is visible as emitted light (see arrows) through the outer layer 22/reflective coating 24 when an electrical charge is supplied to the LEDs 37 of the RDI layer 36.

In an embodiment, the above layers are used to provide a rear-vision mirror-mounted warning indicator as a printed LED decal in any desired shape, such as one or more chevrons (see FIGS. 3A-3B, 4A-4B, and 5A-5B). With reference to FIGS. 3A and 3B, a circuit 42 is provided including switches 44, 46 and printed LED decals 48, 50. As provided, printed LED decals 48, 50 each emit a same light color, typically blue for cost reasons as summarized above. By inclusion of phosphor dye layers 30 as described above, printed LED decal 48 is caused to emit light of a first color, and printed LED decal 50 is caused to emit light of a second color that is different from the first color. A processor 52 is configured to control operation of switches 44, 46, and is operatively connected to both a turn signal control system 54 and a proximity sensor system 56 of the vehicle (not shown).

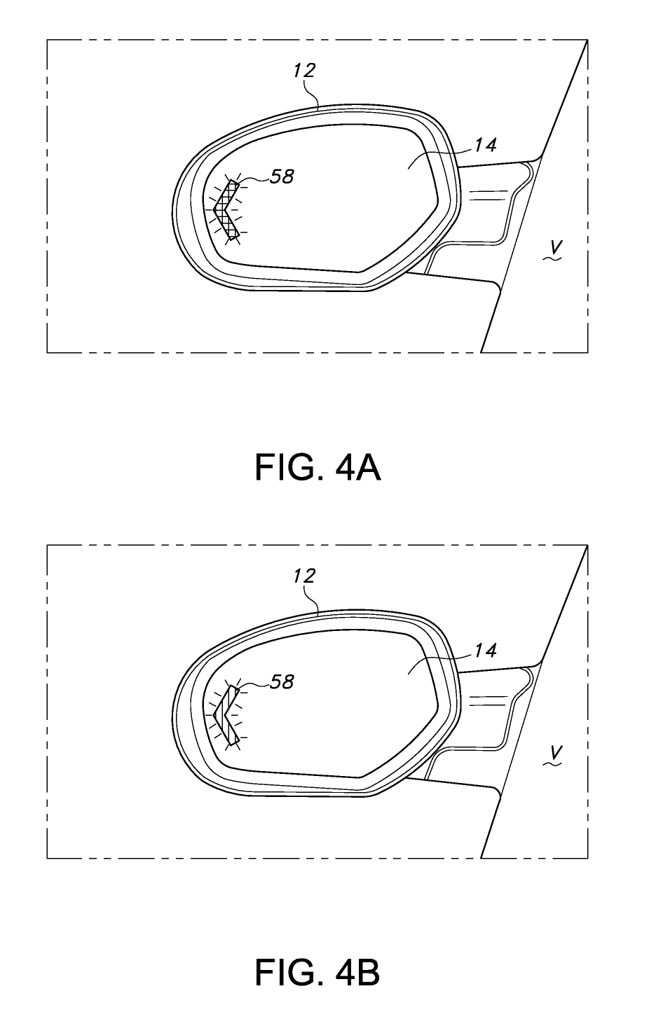

In use, when switch 44 is closed by processor 52 in response to activation of the vehicle turn signal control system 54, printed LED decal 48 emits the first visible signal that is visible through the reflective surface 14 of the rear-vision mirror 12. In the depicted embodiment (see FIG. 4A), this causes warning indicator 58 to flash intermittently in a first color, such as yellow. This alerts other motorists that the vehicle V intends to make a turn or change lanes. In turn, the yellow (or other predetermined color) of the warning indicator 58 serves to indicate to the driver that there is no vehicle in her blind spot, and that the turn or lane change can safely be made.

A driver may desire to make a turn or change lanes when another vehicle (not shown) is in her blind spot, and activates the turn signal control system 54. The presence of the other vehicle would cause the vehicle proximity sensor system 56 to activate. In that situation, processor 52 would receive a signal from both the turn signal control system 54 and the proximity sensor system 56. In turn, processor 52 closes switch 46, causing printed LED decal 50 to emit the second visible signal that is visible through the reflective surface 14 of the rear-vision mirror 12. This causes warning indicator 58 to flash intermittently in a second color, such as red, alerting other motorists that a turn of lane change is contemplated but also alerting the driver that another vehicle is adjacent to her vehicle and that she should not make the turn or lane change until the other vehicle is no longer adjacent to her vehicle.

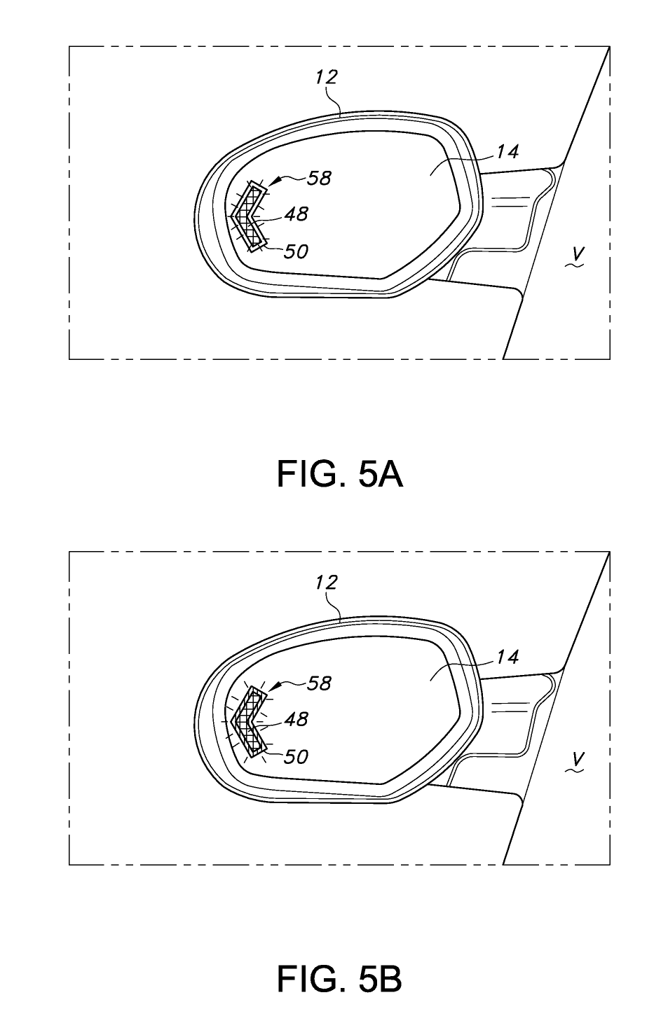

Of course, alternative embodiments are possible and are contemplated herein. For example, as described above printed LED decals 48, 50 are disposed adjacent to one another. In an alternative embodiment as shown in FIGS. 5A and 5B, printed LED decal 48 may be at least partially enveloped or bordered by printed LED decal 50. In this embodiment, activation of the turn signal control system 54 will cause the processor 52 to close switch 44. Then, printed LED decal 48 will emit the first visible signal through the reflective surface 14 of the rear-vision mirror 12. Warning indicator 58 will flash intermittently in the first color (for example yellow). When processor 52 receives a signal from both the turn signal control system 54 and the proximity sensor system 56, both switches 44, 46 close, and printed LED decals 48 and 50 will emit the first and second visible signals, respectively, through the reflective surface 14. This will appear as warning indicator 58 flashing intermittently in the first color (yellow) with a border having the second color (red), alerting the driver to the presence of an adjacent vehicle in her blind spot.

In this manner, a combined turn signal/blind spot indicator warning indicator is provided. The warning indicator is visible through the rear-vision mirror reflective surface, which by use of printed LED technology provides a premium feature to the vehicle in a simple, cost-effective manner. Advantageously, the indicator is significantly larger and more visible than the conventional blind spot indicator, and so is easier to see and more likely to catch the attention of an alert a driver to the presence of an adjacent vehicle in her blind spot. Moreover, printed LED technology provides hundreds of LEDs spread in an even pattern. This provides a much smoother light pattern compared to conventional LED technology which typically uses 5-7 LEDs to create a turn signal indicator, creating a choppy surface to the pattern. Still yet more, provision of a combined turn signal/blind spot indicator in the form of printed LED decals emitting different visual signals as described provides a means for, e.g., color-blind individuals to distinguish between the decal providing a turn signal function and the decal providing the proximity warning function.

Obvious modifications and variations are possible in light of the above teachings. All such modifications and variations are within the scope of the appended claims when interpreted in accordance with the breadth to which they are fairly, legally and equitably entitled.

What is claimed:

1. A warning indicator system for a vehicle, comprising:
an indicator for providing visible signals within a reflective surface of a rear-vision mirror, operatively connected to a proximity sensor system and to a turn signal control system of the vehicle;
wherein the indicator provides a first visible signal when the turn signal control system is activated and provides a second visible signal when the turn signal control system and the proximity sensor system are activated.

2. The system of claim 1, wherein the first visible signal has a first color and the second visible signal has a second color that is different from the first color.

3. The system of claim 2, wherein the indicator comprises a first printed LED symbol for providing the first visible signal and a second printed LED symbol for providing the second visible signal.

4. The system of claim 3, wherein the first and second printed LED symbols are disposed adjacent to one another.

5. The system of claim 3, wherein the first printed LED symbol is at least partially enveloped by the second printed LED symbol.

6. The system of claim 3, further including at least one processor operatively connected to the first printed LED symbol, to the second printed LED symbol, to the turn signal control system, and to the proximity sensor system.

7. The system of claim 6, wherein the processor is configured to actuate the first printed LED symbol in response to a signal received from the turn signal control system.

8. The system of claim 6, wherein the processor is configured to actuate the second printed LED symbol in response to a signal received from the proximity sensor system.

9. A rear-vision mirror assembly for a vehicle, comprising:
a housing holding a reflective surface; and
an indicator for providing visible signals within the reflective surface, operatively connected to a proximity sensor system and to a turn signal control system;
wherein the indicator provides a first visible signal when the turn signal control system is activated and provides a second visible signal when the turn signal control system and the proximity sensor system are activated.

10. The rear-vision mirror assembly of claim 9, wherein the first visible signal has a first color and the second visible signal has a second color that is different from the first color.

11. The rear-vision mirror assembly of claim 10, wherein the indicator comprises a first printed LED symbol for providing the first visible signal and a second printed LED symbol for providing the second visible signal.

12. The rear-vision mirror assembly of claim 11, wherein the first and second printed LED symbols are disposed adjacent to one another.

13. The rear-vision mirror assembly of claim 11, wherein the first printed LED symbol is at least partially enveloped by the second printed LED symbol.

14. The rear-vision mirror assembly of claim 11, further including at least one processor operatively connected to the first printed LED symbol, to the second printed LED symbol, to the turn signal control system, and to the proximity sensor system.

15. The rear-vision mirror assembly of claim 14, wherein the processor is configured to actuate the first printed LED symbol in response to a signal received from the turn signal control system.

16. The rear-vision mirror assembly of claim 14, wherein the processor is configured to actuate the second printed LED symbol in response to a signal received from the proximity sensor system.

17. A vehicle including the rear-vision mirror assembly of claim 9.
